(19) United States
(12) Patent Application Publication
(10) Pub. No.: US 2010/0039900 A1
(43) Pub. Date: Feb. 18, 2010

(54) Volumetric displacement transducer for an underwater acoustic source

(75) Inventors: Michael McAleenan, Georgetown, ME (US); Ray Nagem, Boston, MA (US); Darcy Hornberger, Woburn, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Kazak Composites, Incorporated

(21) Appl. No.: 11/985,319

(22) Filed: Nov. 14, 2007

Related U.S. Application Data
(60) Provisional application No. 60/858,902, filed on Nov. 14, 2006.

(51) Int. Cl. G10K 11/00

(52) U.S. Cl. 367/141

(57) ABSTRACT

A volumetric displacement transducer is provided for generating acoustic signals. The transducer housing incorporates at least one pair of opposed plates mounted for radial vibration. A driving mechanism is coupled to the opposed plates for driving the plates simultaneously in opposition to each other at a desired frequency, whereby an acoustic signal is radiated into a medium, such as water, surrounding the housing.

### CROSS REFERENCE TO RELATED APPLICATIONS

This application claims the benefit under 35 U.S.C. §119(e) of U.S. Provisional Patent Application No. 60/858,902, filed Nov. 14, 2006, the disclosure of which is incorporated by reference herein.

### STATEMENT REGARDING FEDERALLY SPONSORED RESEARCH OR DEVELOPMENT

This invention was developed under Contract STTR N05-T029. The Government may have certain rights in the invention.

### BACKGROUND OF THE INVENTION

Various undersea mine countermeasures are known. For example, in a mine sweeping operation, an unmanned surface vessel (USV) has been used to tow a ship-like magnetic signature source. A light-weight, towable acoustic source is not available, however.

### SUMMARY OF THE INVENTION

A volumetric displacement transducer is provided to generate acoustic signals. The transducer is suitable as an underwater acoustic source useful in, for example, mine sweeping or undersea mapping operations. The acoustic signature can be tuned, for example, to mimic that of a ship. The transducer may have low drag characteristics, allowing it to be readily towed or driven underwater.

More particularly, a portion of the housing incorporates one or more pairs of opposed plates mounted for radial vibration. A driving mechanism is coupled to the opposed plates for driving the plates simultaneously in opposition to each other at a desired frequency, whereby an acoustic signal is radiated into a medium surrounding the housing.

### DESCRIPTION OF THE DRAWINGS

The invention will be more fully understood from the following detailed description taken in conjunction with the accompanying drawings in which:

FIG. 1 is an isometric view of a volumetric displacement transducer according to the present invention;

FIG. 2 is an isometric view of a transducer frequency section with a hexagonal configuration;

FIG. 3 is a further isometric view of the hexagonal transducer section of FIG. 2 with the plates removed;

FIG. 4 is a side view of the hexagonal transducer section of FIG. 2;

FIG. 5 is a cross-sectional view taken along line V-V of the hexagonal transducer section of FIG. 4;

FIG. 6 is an isometric end view of the hexagonal transducer section of FIG. 2;

FIG. 7 is a cross-sectional view taken along line VII-VII of the hexagonal transducer section of FIG. 4;

FIG. 8 is an isometric view of a transducer frequency section with a circular configuration;

FIG. 9 is an isometric view of a driving mechanism for the circular transducer section of FIG. 8;

FIG. 10 illustrates various frequency wheels for a further embodiment of transducer;

FIG. 11 is a further isometric view of the transducer; and

FIG. 12 is an isometric view of a further embodiment of a housing for a transducer.

### DETAILED DESCRIPTION OF THE INVENTION

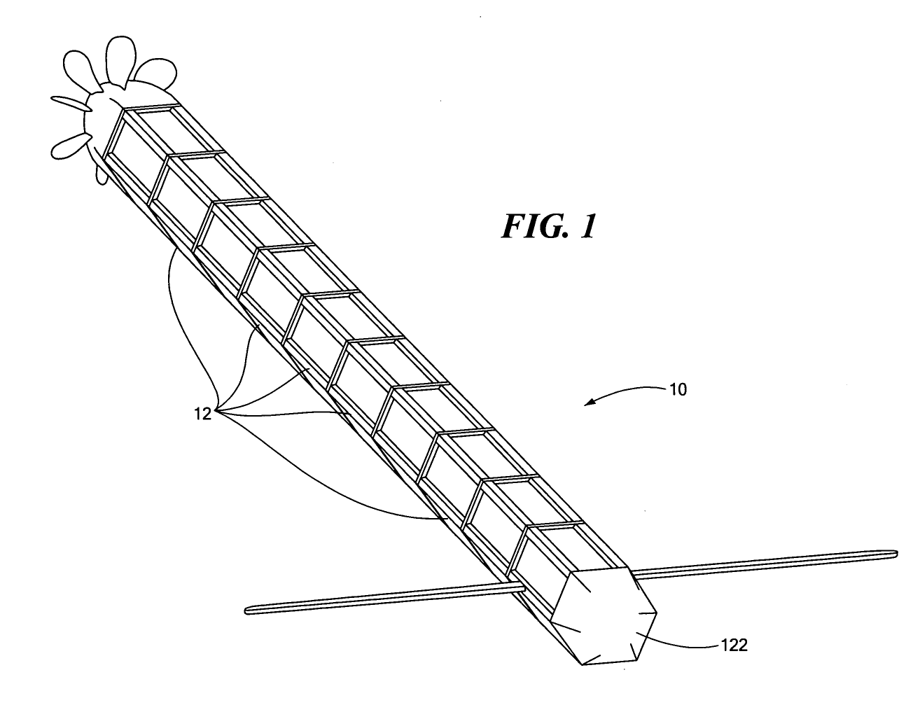

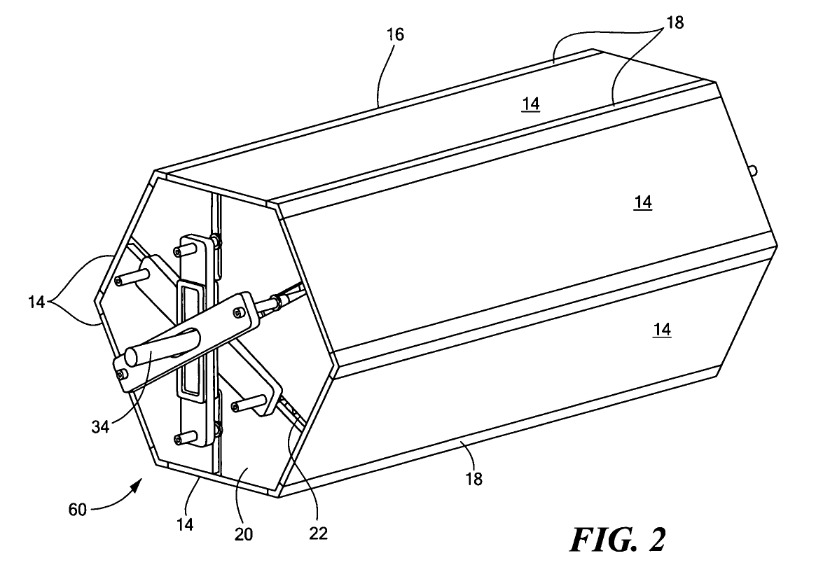

Referring to FIG. 1, a volumetric displacement transducer 10 is providing having a frequency section 12a or an array of frequency sections 12a-12h, each frequency section producing a volumetric displacement capable of generating an acoustic signal at a desired frequency and sound pressure level. Various frequency sections can be combined to produce either discrete or broadband frequency spectrums, as desired. Each frequency section has one or more rigid plates 14 that form part of a housing 16. (See FIG. 2.) The plates are driven by a suitable driving mechanism within the housing to vibrate or translate radially at a desired frequency. Preferably, the plates are disposed in pairs, with each plate mounted opposite to the other plate of the pair, and are driven to vibrate simultaneously in radially opposite directions. When a plurality of plate pairs is provided, each pair of plates is driven outwardly at the same time and at the same frequency as the other pairs of plates in the section. The radial vibrations generate a volumetric displacement of the medium outside the housing, resulting in an outwardly radiating acoustic signal.

The range of radiated sound pressure levels depends on plate area and radial displacement. Increasing or decreasing the transducer volume increases or decreases the cross sectional area, thereby increasing or decreasing the plate area. Radial displacement is determined by the driving mechanism, described further below. The plates are preferably formed to be as stiff and rigid as practicable to reduce bending and flexure during operation, as such motions tend to decrease acoustic radiation efficiency.

To maintain a pressure differential and/or to reduce plate edge effects between the interior and the exterior, the housing is sealed to prevent leakage of the surrounding medium, generally seawater, into the interior. For underwater applications, the housing is preferably flooded with water or seawater or another fluid to minimize stresses on the structure and to simplify the provision of a sealed housing. Air could be used as the interior medium even in underwater applications; however, in this case, sealing the housing against seawater leakage would be more difficult. In one embodiment, the housing is enveloped in a sealed, flexible elastomeric membrane, which is able to expand and contract as the plates vibrate. In another embodiment, the housing is sealed with an interior elastomeric liner membrane in a manner that does not interfere with the vibrations of the plates. Placing the elastomeric sealing membrane on the interior removes the membrane from the exterior environment where it could become damaged during movement through the water. Additionally or alternatively, the plates are mounted within the housing with a seal around their edges. If there is no elastomeric material around the plate edges, fluid flows around the plate edges, effectively decreasing plate area, known as edge effects.

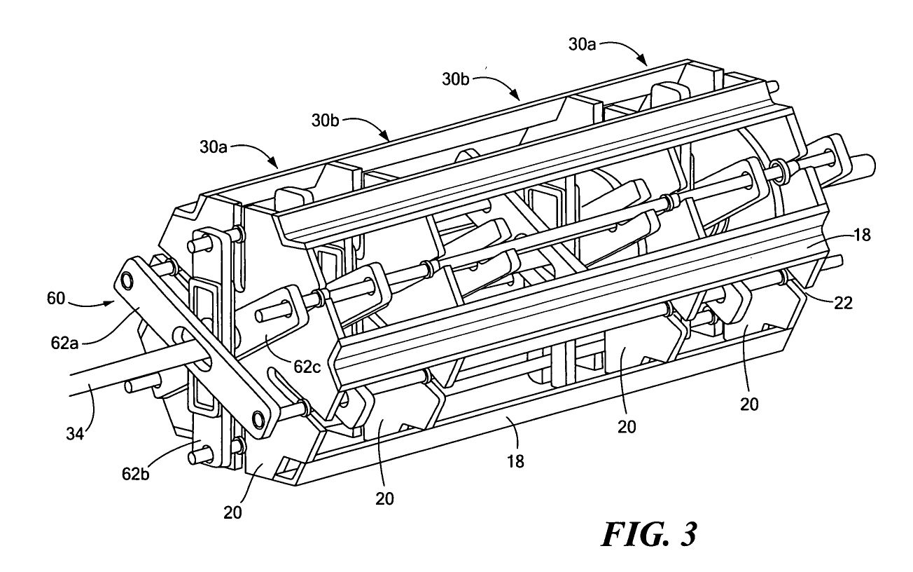

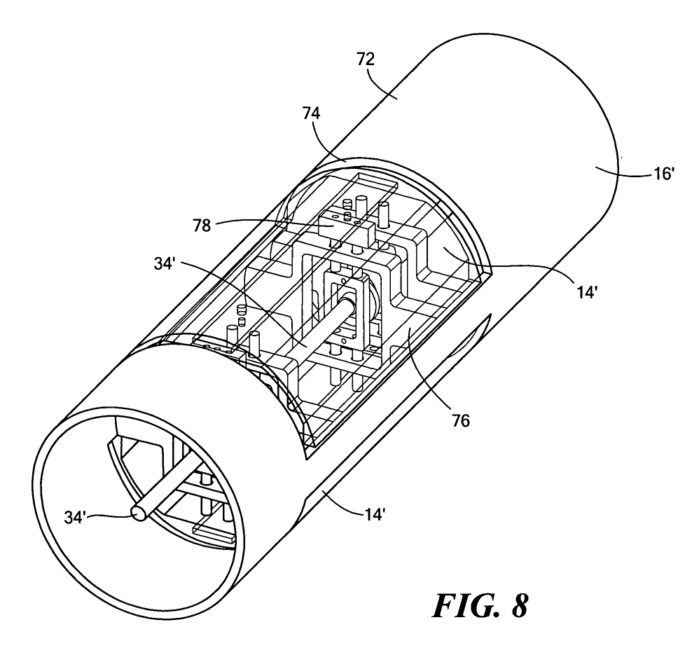

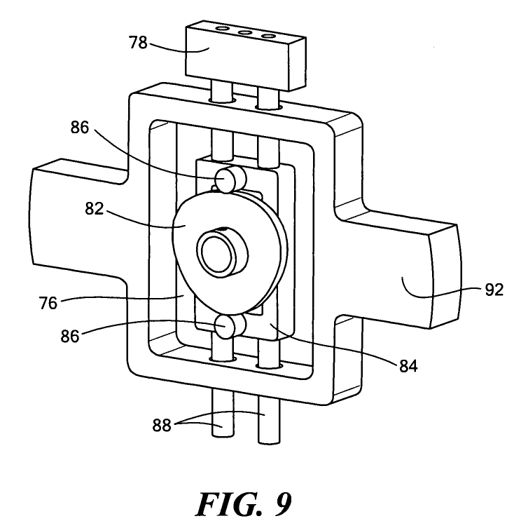

Preferably, the plates constitute a majority and, more preferably, substantially all of the surface area of the housing, so that as much area as possible is available for displacing the surrounding fluid. Structural support for the plates and driving mechanism can be provided in any suitable manner. For example, the housing can employ longitudinal rails or stringers 18 between the plates, and rigid bulkheads 20 can be placed within the housing. In one embodiment, the housing is hexagonal in cross section, and three pairs of rigid flat plates are provided. See FIGS. 2-7, which illustrate one frequency section 12a having a hexagonal configuration. In another embodiment, the housing 16, is cylindrical in cross section, and a pair of curved plates 14′ are provided. See FIGS. 8 and 9. Flat plates are, however, more efficient acoustical radiators than curved plates, because the entire area of the plate is available to displace the greatest amount of the surrounding fluid in the direction of displacement. Thus, the hexagonal cross-sectional configuration is generally preferred to the circular cross-sectional configuration when considering acoustical efficiency. The circular cross-sectional configuration provides lower drag through the fluid medium. Other cross-sectional configurations, such as square or octagonal, could be used if desired.

Referring to the hexagonal configuration illustrated in FIGS. 2-7, the transducer frequency section 12a housing 16 is formed of six flat plates 14 supported by a linkage assembly, discussed further below. Rails extending along the longest edges of the plates are fixed to and supported by several bulkheads 20. The rails may have any suitable configuration, such as angled or rhomboidal, to provide strength and stiffness to the housing. The bulkheads may be appropriately notched to receive the rails. In the embodiment of the frequency section shown, four bulkheads are used, one bulkhead located at each end and two located in the interior of the section. The bulkheads also include slots 22 through which sets of bearing support rods 24, 26 pass, described further below. Sleeve bearings 28 are disposed in the bulkhead slots to reduce friction and/or support the bearing rods.

The bulkheads 20 also separate adjacent frequency sections. The open bulkheads ensure equal pressure along the length of the flooded housing. Also the bulkheads isolate the frequency sections to reduce interactions between the frequency sections. For example, the bulkheads can be mounted with cutlass bearings (water lubricated rubber bearings). Thus, the primary interaction between the frequency sections of the transducer is through the fluid medium within the shell.

The driving mechanism incorporates a number of linkage assemblies 30a, 30b each associated with a cam assembly 32a, 32b mounted on a rotatable shaft 34 that extends along a central axis of the housing. The shaft is rotated in any suitable manner, such as by an electric or pneumatic motor on one end or by a prop on the aft end. In the hexagonal embodiment shown, each linkage assembly drives three of the six plates. Thus two linkage assemblies are required to drive all six plates. Additionally, the plates are preferably each supported by and driven by two linkage assemblies, one located close to each end of the plates, for a total of four linkage assemblies. By supporting the plates at or close to both ends, bending and rotation of the plates is minimized, thereby increasing acoustic efficiency.

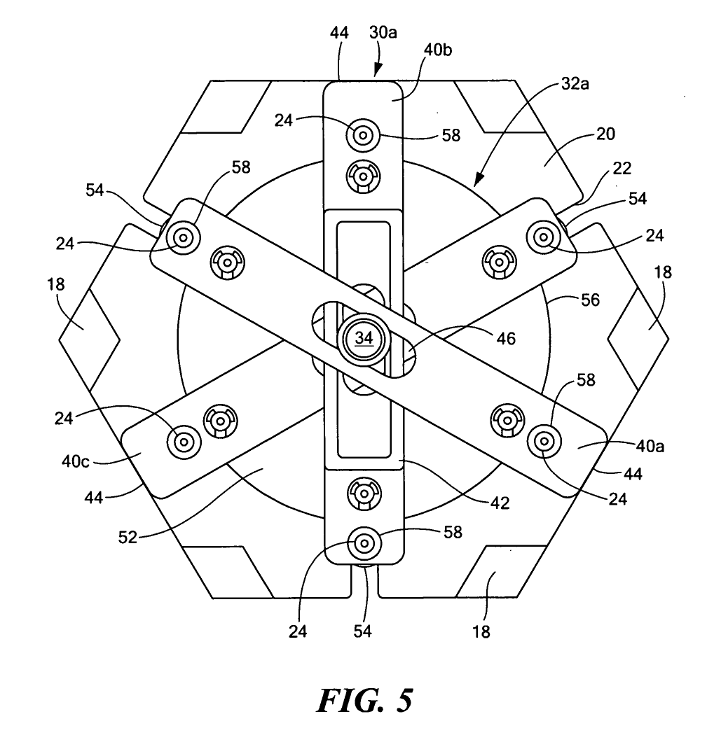

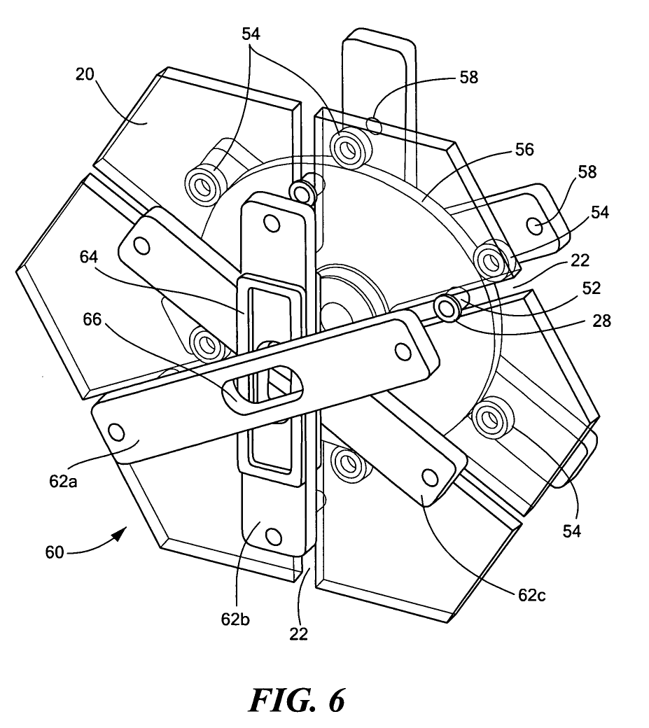

A first cam assembly 32a and a first linkage assembly 30a are illustrated more particularly in FIGS. 5-6. Each linkage assembly is formed of three link arms 40a, 40b, 40c, that support the vibrating plates. The link arms are separated by spacers 42 and are mounted on the bearing support rods 24 for reciprocating radial translation. One end 44 of each link arm is fixed to the underside of an associated one of the plates. A centrally located slot 46 in each link arm allows reciprocating radial translation or vibration of the link arm over the shaft 34.

The cam assembly 32a includes a cam 52 mounted for rotation on the rotatable shaft that extends through the housing. Bearings 54 ride on the peripheral cam surface 56 of the cam, which is suitably configured to cause radial movement of the bearings as the cam rotates. The bearing support rods 24 extend through the bearings 54, constraining the bearings to radial translation, and through apertures 58 near each end edge of each link arm 40a-40c. The bearing support rods thus also translate or vibrate radially, and because they are fixed to the link arms, cause the link arms to translate or vibrate radially. One bearing and bearing support rod through the link arm of the first linkage assembly cause the plate to translate outwardly, and the other bearing and bearing support rod through the opposite end of the link arm cause the plate to return by translating radially inwardly. Consequently, the plates fixed to the ends of the link arms of the first linkage assembly vibrate radially.

The bearing support rods 24 are also fixed to a support linkage 60 at each end of the housing, which prevents or minimizes bending of the bearing support rods. The support linkage is formed of three link arms 62a, 62b, 62c that are also capable of radial translation with the bearing support rods. Spacers 64 are provided between the three link arms. Each link arm includes a centrally located slot 66 that allows reciprocating radial translation of the link arm over the shaft 34.

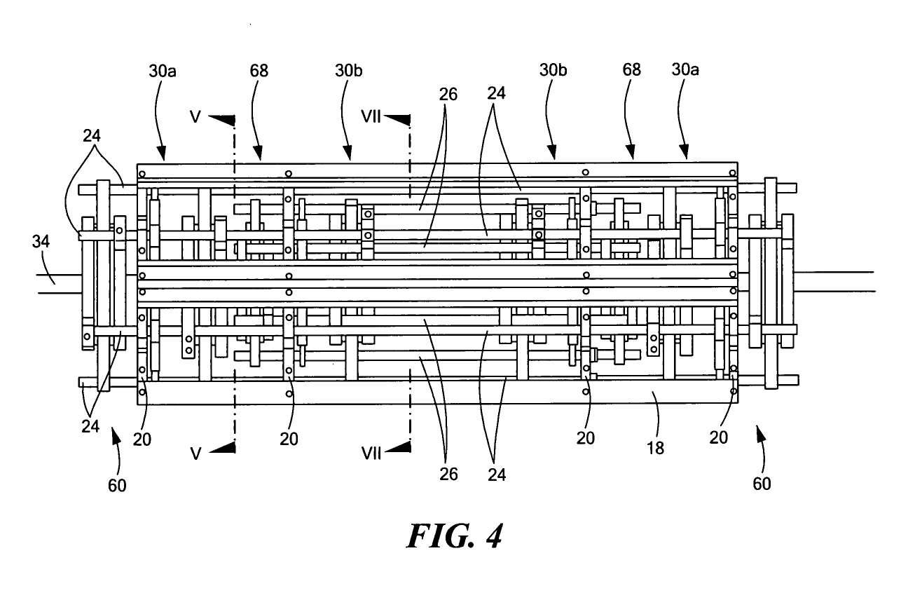

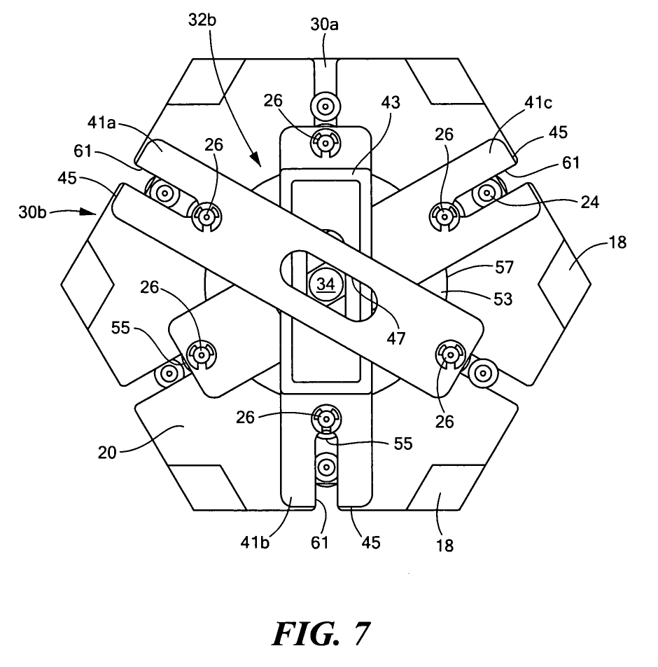

As noted above, one cam assembly 32a and linkage assembly 30a drives three plates. A second, similar cam assembly 32b and linkage assembly 30b, offset by 60°, is provided to drive the other three plates. As shown in FIG. 7, the second cam assembly and linkage assembly are smaller in overall diameter to fit within the bearing support rods 24 used with the first cam and linkage assemblies. The linkage assembly 30b includes three link arms 41a, 41b, 41c separated by spacers 43. Slots 61 are provided in the link arms of the second linkage assembly to allow unobstructed passage of the first set of bearing support rods 24 for the first linkage assembly. One end 45 of each link arm is affixed to the underside of an associated one of the plates. A centrally located slot 47 in each link arm allows reciprocating radial translation or vibration of the link arm over the shaft 34. The second linkage assembly includes a second set of bearing support rods 26, which are also supported by two support linkages 68 at their ends to prevent or minimize bending. (See FIG. 4.) The bearing support rods 26 extend through bearings 55 in each link arm that ride on the peripheral surface 57 of the cam 53, configured to cause radial movement of the bearings as the cam rotates.

Referring to the circular configuration illustrated in FIGS. 8 and 9, the transducer frequency section housing 16′ is formed of a cylindrical shell 72 having two openings 74 therein. Arcuate plates 14′ (shown in phantom in FIG. 8) are disposed within the openings.

The driving mechanism employs a cam assembly 76 and push block 78 associated with each plate. The cam assembly includes a cam 82 mounted for rotation on a shaft 34′ that extends along a central axis of the housing. A cam follower 84 is mounted for radial translation via track bearings 86 that travel about the perimeter of the cam as the cam rotates. One track bearing causes the cam follower to translate radially outwardly, and the other track bearing causes the cam follower to return by translating radially inwardly. The push block is mounted via posts 88 to the cam follower. The push block is fixed to an underside of the plate. The posts are constrained to translate radially by extending through apertures in a follower support member 92 that is fixed within the shell. The follower support member also holds the cam, cam follower and push block in place within the shell. Thus, the plate attached to the push block can be driven to vibrate radially. A second cam assembly and push block is provided for the opposite plate. Also, the plates are preferably supported at each end by a second cam assembly and push block, to minimize bending.

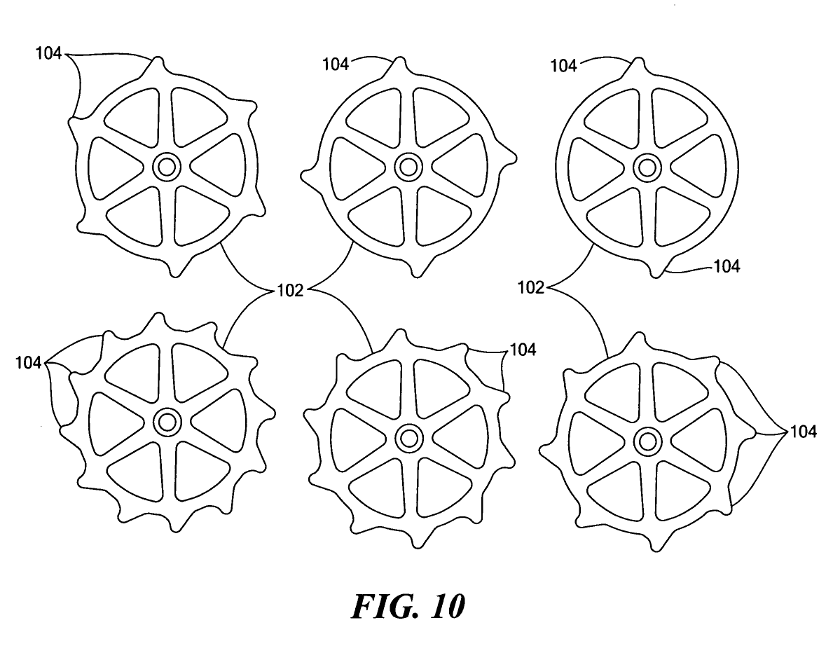

In another embodiment, a driving mechanism to cause vibration or reciprocating radial translation of the plates employs a number of frequency wheels or cams 102 mounted on a rotating shaft for rotation therewith. See FIG. 10. One type of frequency wheel is associated with each frequency section of the transducer. The frequency wheels have multiples of two bumps or nubs 104 arranged in opposed pairs on the perimeter of the wheel. As the frequency wheel rotates, the opposed bumps impact the opposed plates simultaneously, causing the plates to vibrate simultaneously. Frequency is determined by shaft rotation and the number of opposing bumps on the frequency wheels or cams.

The vibrating plates, which form a part of the housing, can be mounted to the surrounding part of the housing in other ways that allow radial vibrational movement. For example, the edges of the plates and the abutting edges of the surrounding shell can have a tongue and groove configuration that permits radial vibrational movement of the plates while they remain part of the housing. The plates can have a variety of configurations. For example, the plates can be flat or curved. The edges of the plates can be straight or curved. For single and radial aligned arrays the plates can be spherical in shape with edges that are straight or curved.

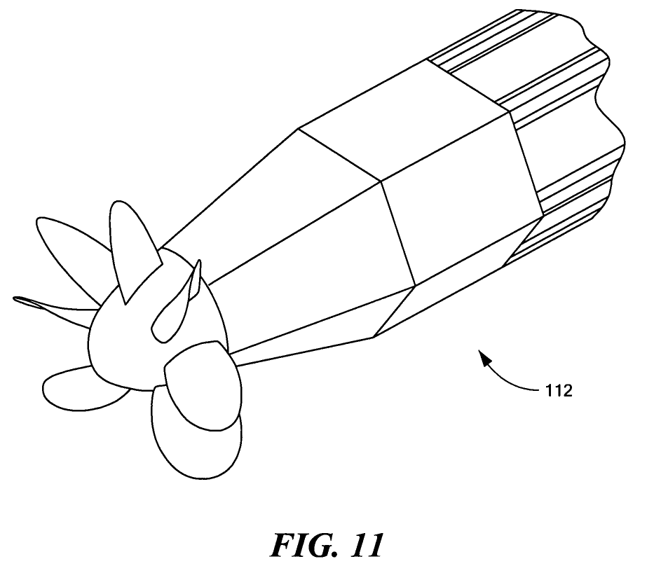

A Helmholtz resonator can be integrated into the body of the transducer. In this case, the diameter of the aft section 112 is reduced so that it acts as a neck of a Helmholtz resonator. See FIG. 11. A plug that oscillates back and forth based on shaft rotation is located on the shaft in the neck. The shaft is milled as a slip shaft in the region of the plug to permit shaft rotation to translate the Helmholtz plug up to an end stop. Internal hydrostatic pressure forces the plug to slide back down the shaft. This cyclic action excites the resonator at particular frequencies. The Helmholtz resonator can also be passive, in which fluid internal to the housing acts as the plug of the Helmholtz resonator by fluctuating back and forth as the plates vibrate. This is another reason to isolate the internal fluid from the external fluid.

FIG. 1 illustrates a transducer with a number of volumetric displacement sections 12. A gear reduction can be provided between sections to achieve desired frequencies. For example, eight transducer sections could be configured to provide frequencies at intervals of 60 Hz in front of the gear reduction, 60 Hz, 120 Hz, 180 Hz, 240 Hz, 300 Hz, and 360 Hz, and aft of the gear reducer, 20 Hz and 40 Hz. Transducer sections can vary from one to as many as are required to meet design requirements.

The transducer is preferably packaged as a low-drag, constant or variable cross-section structure that can be towed or driven through water. For example, the housing may have a streamlined body shape and may include a nose cone 122 at the forward end and, if necessary, a cone cowling at the rear end to reduce drag.

The nose and tail cones, internal bulkheads, longitudinal stringers and housing, including the plates and surrounding shell, are preferably formed of glass or carbon fiber reinforced composites. These composite components suitably use vinyl-ester or epoxy resins. Carbon reinforcement may be used to increase stiffness of the rigid plates. Core material may also be used to increase stiffness of the plate. Possible core materials are lightweight closed cell foams, balsa, or similar materials. The plates are preferably glass or carbon sandwich composite material panels. Components of the driving mechanism, such as the shaft and linkage and cam assemblies, are suitably made from a metal such as aluminum, due to aluminum's greater modulus compared to glass and lower cost compared to carbon.

The transducer can be towed through the water by a cable attached to a surface vessel. If desired, power for the driving mechanism can be delivered with a power cable integrated with the tow cable. A battery power source can also be provided on board the transducer. The transducer can also be self-propelled, for example, via a suitable propeller at the aft end. A propeller can also be used as an alternative back up power supply at higher tow speeds. The propeller can be a folding propeller or can be housed until needed. FIG. 1 illustrates a propeller with a protective hydrodynamic cowling removed.

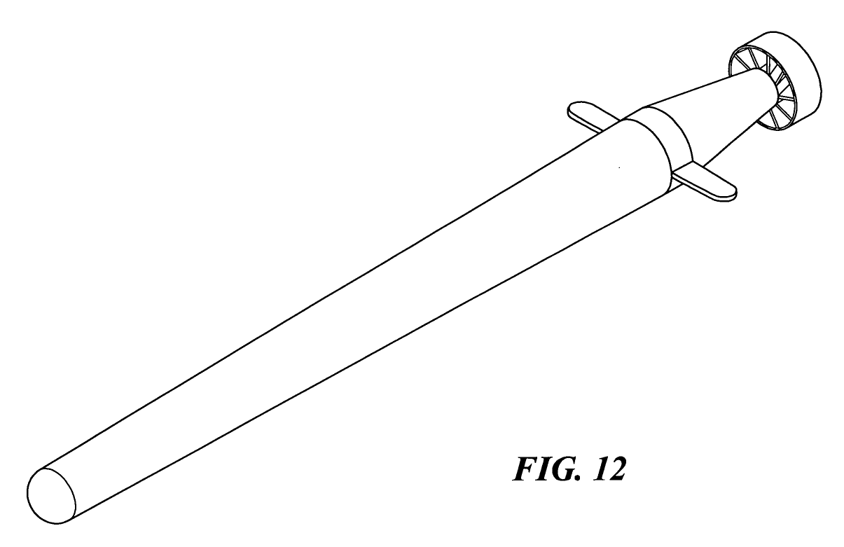

FIG. 12 illustrates an alternate embodiment of a volumetric transducer housing. At higher towed speeds, turbulent or chaotic flow around the transducer could reduce radiated acoustic sound pressure levels. To address this concern, the diameter of the housing is gradually increased to improve laminar flow at high speeds. The housing is illustrated with a circular cross section; however, other cross sectional configurations besides circular can be used.

The transducer can have a neutral buoyancy to ensure that if the transducer's cable connection fails, the transducer can float to the surface for retrieval. Rotating hydrofoils permits adjustments to the angle of attack to operate the transducer at specific depths.

The volumetric displacement transducer of the present invention is able to mimic the acoustic signature of ships. It can generate low bandwidth frequencies and the frequencies can be selected. The transducer can radiate with high radiated sound pressure levels. The outer housing reduces drag resistance when towed through water. The flooded interior reduces structural stress and weight in the water. The transducer has approximately neutral buoyancy for ease of launch and recovery and to allow the transducer to float in an emergency. The transducer can incorporate fixed or active hydrodynamic control surfaces for variable depth operation. Power requirements are low and the transducer can operate for extended periods of time. The transducer housing can be made durable to withstand impacts. The transducer is low maintenance.

The invention is not to be limited by what has been particularly shown and described, except as indicated by the appended claims.

What is claimed is:

1. A volumetric displacement transducer for generating acoustic signals, comprising:
a housing, a portion of the housing comprising at least one pair of opposed plates, the plates mounted for radial vibration with respect to a central axis of the housing; and
a driving mechanism, the driving mechanism coupled to the opposed plates for driving the plates simultaneously in opposition to each other at a desired frequency, whereby an acoustic signal is radiated into a medium surrounding the housing.

2. The transducer of claim 1, wherein the plates are flat.

3. The transducer of claim 1, wherein the plates are curved.

4. The transducer of claim 1, further comprising a flexible membrane covering the housing, the membrane sealing an interior of the housing from the surrounding medium and allowing radial vibration of the plates.

5. The transducer of claim 1, wherein the plates comprise a majority of an outer surface area of the housing.

6. The transducer of claim 1, further comprising a second pair of opposed plates and a third pair of opposed plates, wherein the pairs of opposed plates are disposed in a hexagonal cross-sectional configuration.

7. The transducer of claim 1, wherein the pair of plates is disposed in a circular cross-sectional configuration.

8. The transducer of claim 1, wherein the driving mechanism comprises a linkage assembly affixed to an interior surface of each plate of the pair of plates, the linkage assembly mounted for reciprocating radial translation.

9. The transducer of claim 1, wherein the driving mechanism comprises:
cam assembly mounted for rotation on a rotatable drive shaft extending axially along the housing,
a linkage assembly affixed to an interior surface of each plate of the pair of plates, and
a bearing mechanism interfacing between the cam assembly and the linkage assembly, the bearing mechanism comprising at least a bearing affixed to the linkage assembly and supported on a cam surface of the cam mechanism, the cam surface configured to provide radial translation of the bearing during rotation of the cam assembly.

10. The transducer of claim 9, wherein the bearing mechanism further comprises at least one bearing support rod supporting the linkage assembly and constraining the linkage assembly and the bearing to translate radially during rotation of the cam assembly.

11. The transducer of claim 10, wherein the bearing support rod is supported at opposed ends thereof by a support linkage.

12. The transducer of claim 9, wherein the linkage assembly comprises a link arm associated with each plate, each link arm mounted for radial translation over the drive shaft.

13. The transducer of claim 1, further comprising a second pair of opposed plates and a third pair of opposed plates, wherein the pairs of opposed plates are disposed in a hexagonal cross-sectional configuration; and
wherein the driving mechanism comprises:
a drive shaft extending axially along the housing,
a first cam assembly mounted for rotation on the drive shaft,
a first linkage assembly affixed to an interior surface of one plate from each of the pairs of plates,
at least one bearing affixed to the first linkage assembly and supported on a cam surface of the first cam assembly, the cam surface configured to provide radial translation of the bearing during rotation of the first cam assembly,
a second cam assembly mounted for rotation on the drive shaft,
a second linkage assembly affixed to an interior surface of the other plate from each of the pairs of plates, the second linkage assembly offset by 60° from the first linkage assembly, and
at least one bearing affixed to the second linkage assembly and supported on a cam surface of the second cam assembly, the cam surface configured to provide radial translation of the bearing during rotation of the second cam assembly.

14. The transducer of claim 1, wherein the driving mechanism comprises a cam assembly associated with each plate and mounted for rotation about the central axis, and a push block disposed to reciprocate radially as the cam assembly rotates, the push block affixed to an interior surface of the plate.

15. The transducer of claim 1, wherein the driving mechanism includes a rotatable shaft extending along the central axis of the housing.

16. The transducer of claim 1, further comprising a propeller disposed at one end of the housing.

17. The transducer of claim 1, wherein the housing comprises a first frequency section; and
further comprising at least one additional frequency section, the additional frequency section comprising at least another additional pair of plates mounted for radial vibration; and
the driving mechanism is coupled to the additional pair of plates for driving the plates of the additional pair of plates simultaneously in opposition to each other at a different desired frequency, whereby an acoustic signal having multiple frequencies is radiated into the surrounding medium.

18. The transducer of claim 17, further comprising a Helmholtz resonator disposed within the housing.
